(19) United States
(12) Patent Application Publication
(10) Pub. No.: US 2011/0205889 A1
(43) Pub. Date: Aug. 25, 2011

(54) Controlling packet transmission

(75) Inventors: Mingyu Chen, Stockholm (SE); Christoffer Rodbro, Stockholm (SE); Soren Vang Andersen, Luxembourg (LU)

(73) Assignee: Skype Limited, Dublin (IE)

(21) Appl. No.: 12/927,214

(22) Filed: Nov. 9, 2010

(30) Foreign Application Priority Data
Feb. 25, 2010 (GB) 1003199.5

(51) Int. Cl. H04L 12/56

(52) U.S. Cl. 370/230

(57) ABSTRACT

Disclosed is a method of controlling transmission of data transmitted in packets from a transmitter to a receiver via a channel. The method comprises transmitting packets from the transmitter to the receiver; determining if the transmission delay and/or loss of subsequent packets transmitted to the receiver may be reduced beyond a threshold amount; controlling the transmission rate to be dependent on a first target delay if it is determined that the transmission delay and/or loss of subsequent packets transmitted to the receiver may not be reduced beyond a threshold amount; and controlling the transmission rate to be dependent on a second target delay if it is determined that the transmission delay and/or loss of subsequent packets transmitted to the receiver may be reduced beyond a threshold amount, wherein the second target delay is lower relative to the first target delay.

### FIELD OF THE INVENTION

The present invention relates to controlling packet transmission and in particular controlling packet transmission in dependence on changing network conditions in packet based communication systems. This invention is particularly but not exclusively related to real time IP communication systems.

### BACKGROUND OF THE INVENTION

Modern communication systems are based on the transmission of digital signals between end-points, such as user terminals, across a packet-based communication network, such as the internet. Analogue information such as speech may be input into an analogue-to-digital converter at a transmitter of one terminal and converted into a digital signal. The digital signal is then encoded and placed in data packets for transmission over a channel via the packet-based network to the receiver of another terminal.

Data packets transmitted via a packet switched network such as the Internet, share the resources of the network. Data packets may take different paths to travel across the network to the same destination and are therefore not transmitted via a dedicated ‘channel’ as in the case of circuit switched networks. However, it will be readily appreciated by a person skilled in the art that the term ‘channel’ may be used to describe the connection between two terminals via the packet switched network, and that the capacity of such a channel describes the maximum bit rate that may be transmitted from the transmitting terminal to the receiving terminal via the network.

Such packet-based communication systems are subject to factors which may adversely affect the quality of a call or other communication event between two end-points. As the growth of the internet increases and users demand new applications and better performance, the rise in data volume generates problems such as long delays in delivery of packets and lost packets. These troubles are due to congestion, which happens when there are too many sources sending too much data too fast for the network to handle.

A number of methods exist for controlling packet transmission in order to avoid network congestion. Symptoms of network congestion include increased packet delay and packet loss which can significantly affect the quality of the received data stream, particularly for real time communications.

Congestion within the network typically occurs at edge routers which sit at the edge of the network. A router typically maintains a set of queues, with one queue per interface that holds packets scheduled to go out on that interface. These queues often use a drop-tail discipline, in which a packet is put into the queue if the queue is shorter than its maximum size. When the queue is filled to its maximum capacity, newly arriving packets are dropped until the queue has enough room to accept incoming traffic.

A number of methods exist for controlling network congestion. Typically, when packet loss occurs, the rate at which data is transmitted is reduced in order to reduce network congestion. TCP (Transmission Control Protocol) is the dominant transport protocol in the Internet. For TCP, the ‘sending rate’ is controlled by a congestion window which is halved for every window of data containing a packet drop, and increased by roughly one packet per window of data otherwise. This is known as Additive Increase Multiplicative Decrease (AIMD).

While TCP congestion control is appropriate for applications such as bulk data transfer, some applications where the data is being played out in real-time find halving the sending rate in response to a single congestion indication to be unnecessarily severe, as it can noticeably reduce the user-perceived quality. TCP's abrupt changes in the sending rate have been a key impediment to the deployment of TCP's end-to-end congestion control by emerging applications such as real time multi-media communications.

Congestion control of real-time communications in the Internet is particularly important since the adverse effects on the data transmission will be noticeable. To achieve TCP-friendliness, or fairness across connections using different protocols, currently rate control solutions for real-time communication can be classified into the following methods.

Some methods employ generalized AIMD algorithms, such as binomial controls that operate in a similar manner to AIMD used in TCP. In these methods the sending rate is increased until packet loss is detected. In response to detecting packet loss the sending rate is reduced.

Other methods may control the transmission rate as a function of RTT and loss rate. TFRC (TCP Friendly Rate Control) is one representative method designed for real-time applications.

These solutions, make tradeoffs among smoothness, aggressiveness, and responsiveness. Compared with TCP, generalised AIMD and TFRC have shown that typically higher smoothness means less aggressiveness and responsiveness. Both categories of methods are loss-based in which loss and high delay is inherent. For real time communication, low delay and no loss are desirable—as such the above solutions have serious drawbacks for real time communication.

Delay-based TCP solutions, such as TCP Vegas, Fast TCP etc., exploit delay information as a congestion index instead of loss only. The basic idea behind delay-based solutions is to maintain certain queue length in the buffer, in order to avoid filling the buffer completely.

For example, Fast TCP updates a window size w defining the amount of data transmitted based on

w(n+1)=w(n)+α−w(n)T_{g}/RTT Equation (1)

Where α is buffer set-point, T_{q} is the total queuing delay, n is the index number for the nth update and RTT is the round trip time. Equation (1) can also be written as:

R(n+1)=R(n)+α/RTT−R(n)T_{q}/RTT Equation (2)

Where R(n)=w(n)/RTT, which is an estimation of the sending rate.

Equations 1 and 2 suffer from the problem that the buffer set point a is not adaptive. The performance of these delay based solution may fall back to traditional TCP if the total buffer requirement of the flows sharing a bottleneck exceeds the buffer limit.

D+M TCP (Delay+Marking TCP) rate controller, described in M. Chen, X. Fan, M. Murthi, T. Wickramarathna, and K. Premaratne, “Normalized Queuing Delay: Congestion Control Jointly Utilizing Delay and Marking,” IEEE/ACM Transactions on Networking, 2009, allows the buffer set point to be managed even when a number of flows share the buffer. This method is based on the notion of a normalized queuing delay, which serves as a congestion measure by combining both delay and ECN (Explicit Congestion Notification) marking information from AQM (Active Queue Management) performed at routers. Utilizing normalized queuing delay (NQD), D+M TCP allows a source to scale its transmitting rate dynamically to prevailing network conditions through the use of a time-variant buffer set-point. D+M TCP updates the rate according to

R(n+1)=R(n)+K{N_{T}−R(n)T_{q}(n)} Equation (3)

where T_{q} is the queuing delay in the forward path, N_{T} is the adaptive target buffer set point representing the amount of data queued for a particular flow and K is the step size.

The adaptive buffer set point N_{T} is given by:

N_{T}=α/ [symbol] (p) Equation (4)

where α is a constant and where [symbol] (p) is a normalizing function of a marking probability p, which can be calculated from the ECN marking in the IP header.

The marking probability p is a function of the capacity of the buffer, and the average queue length. According to Equation 4, N_{T} will vary in order to keep the average queue length at the buffer within a predefined operating range.

The inventors of the current invention have identified that D+M TCP suffers from the problem that it is not particularly suitable for real time audio and video communication, since even though the adaptive buffer set point is adaptive to the number of flows sharing the buffer, the predefined operating range of the queue length is in the buffer is fixed. This introduces unnecessary delay in some cases, or conversely prevents the packet flow achieving a fair share of the buffer capacity when the buffer is shared with TCP like cross traffic.

It is an aim of the present invention to mitigate the problems discussed above.

### STATEMENT OF INVENTION

According to a first embodiment of the invention there is provided a method of controlling transmission of data transmitted in packets from a transmitter to a receiver via a channel, the method comprising: transmitting packets from the transmitter to the receiver; determining if the transmission delay and/or loss of subsequent packets transmitted to the receiver may be reduced beyond a threshold amount; controlling the transmission rate to be dependent on a first target delay if it is determined that the transmission delay and/or loss of subsequent packets transmitted to the receiver may not be reduced beyond a threshold amount; and controlling the transmission rate to be dependent on a second target delay if it is determined that the transmission delay and/or loss of subsequent packets transmitted to the receiver may be reduced beyond a threshold amount, wherein the second target delay is lower relative to the first target delay.

According to a second aspect of the invention there is provided a method of controlling transmission of data from a transmitter to a receiver via a channel, the method comprising: transmitting data from the transmitter to the receiver; determining if the transmission delay and/or loss of subsequent packets transmitted to the receiver may be reduced beyond a threshold amount; controlling the transmission rate to maintain a first target amount of data transmitted from the transmitter to the receiver queued in the channel if it is determined that the transmission delay and/or loss of subsequent packets transmitted to the receiver may be not be reduced beyond the threshold amount; and controlling the transmission rate to maintain a second target amount of data transmitted from the transmitter to the receiver queued in the channel if it is determined that the transmission delay and/or loss of subsequent data transmitted to the receiver may be reduced beyond the threshold amount, wherein the second target amount of data is lower relative to the first target amount of data.

According to a third aspect of the invention there is provided a transmitter for transmitting data provided in packets to a receiver via a channel, the transmitter comprising: a determiner configured to determine if the transmission delay and/or loss of subsequent packets transmitted to the receiver may be reduced beyond a threshold amount; and a controller configured to control the transmission rate to be dependent on a first target delay if it is determined that the transmission delay and/or loss of subsequent packets transmitted to the receiver may not be reduced beyond a threshold amount; and to control the transmission rate to be dependent on a second target delay if it is determined that the transmission delay and/or packet loss may be reduced beyond a threshold amount, wherein the second delay tolerance is lower relative to the first delay tolerance.

According to a fourth aspect of the invention there is provided a receiver arranged to receive data provided in packets transmitted from a transmitter via a channel, the receiver comprising: a determiner configured to determine if the transmission delay and/or loss of subsequent packets transmitted to the receiver may be reduced beyond a threshold amount; and a controller configured to control the transmission rate to be dependent on a first target delay if it is determined that the transmission delay and/or loss of subsequent packets transmitted to the receiver may not be reduced beyond a threshold amount; and to control the transmission rate to be dependent on a second target delay if it is determined that the transmission delay and/or loss of subsequent packets transmitted to the receiver may be reduced beyond a threshold amount, wherein the second delay tolerance is lower relative to the first delay tolerance.

### BRIEF DESCRIPTION OF DRAWINGS

For a better understanding of the invention and to show how the same may be carried into effect, reference will now be made by way of example to the accompanying drawings in which:

FIG. 1 is a schematic diagram of a communication system, illustrating flow of packets between a transmitter and a receiver;

FIG. 2 is a schematic diagram of a packet queue at a buffer;

FIG. 3 is a schematic diagram illustrating cross traffic at the buffer;

FIG. 4 is a graph illustrating the normalizing function according to an embodiment of the present invention;

FIG. 5 is a schematic block diagram of circuitry at a transmitter to implement one embodiment of the invention;

FIG. 6 is a flow chart illustrating a method according to an embodiment of the present invention

### DETAILED DESCRIPTION

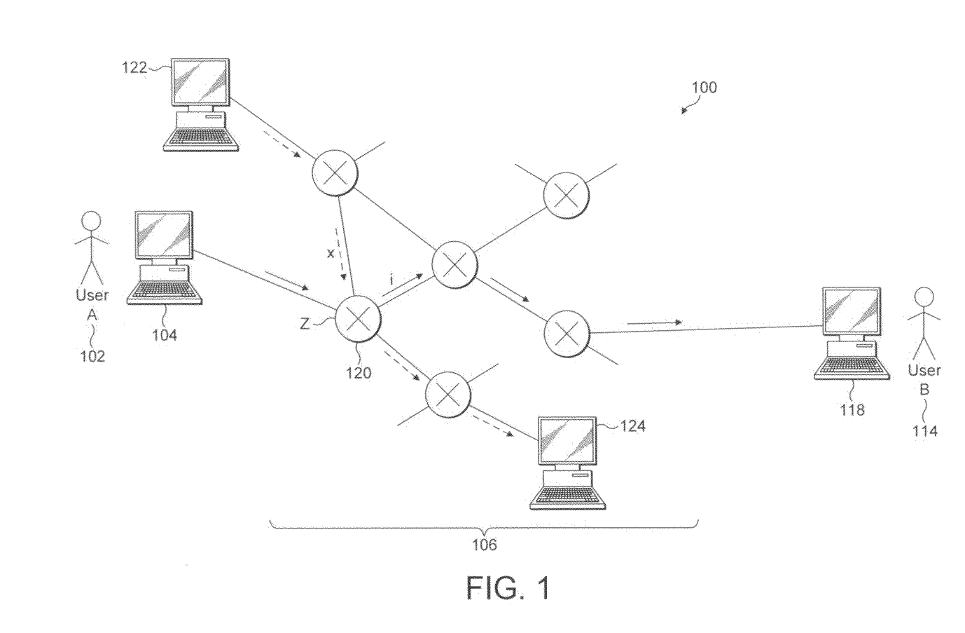

Reference is first made to FIG. 1 which illustrates a communication system 100 used in an embodiment of the present invention. A first user of the communication system (denoted “User A” 102) operates a first user terminal 104, which is shown connected to a network 106, such as the Internet. The user terminal 104 may be, for example, a personal computer (“PC”), mobile phone, gaming device or other embedded device able to connect to the network 106. The first user terminal 104 has a user interface means to receive information from and output information to User A. The interface means of the user terminal comprises a speaker, a microphone, a display means such as a screen, a webcam and a keyboard. The user terminal is connected to the network 106 via a network interface such as a modem access point or base station. User B 114 operates a second user terminal 118. During a call between User A and User B, data packets such as audio data packets and video data packets will be transmitted via the network.

Data packets traverse the Internet 106 via routers 120. Data packets are queued in the buffer of a router before being forwarded across the Internet 106. A number of routers are used to route packets between the first user terminal 104 and the second user terminal 118. A buffer that is close to capacity may introduce a bottleneck to the transmission of data packets. If the capacity of the buffer is exceeded, packet loss will occur. A buffer that potentially introduces loss and delay in the packet flow is referred to as the bottleneck buffer.

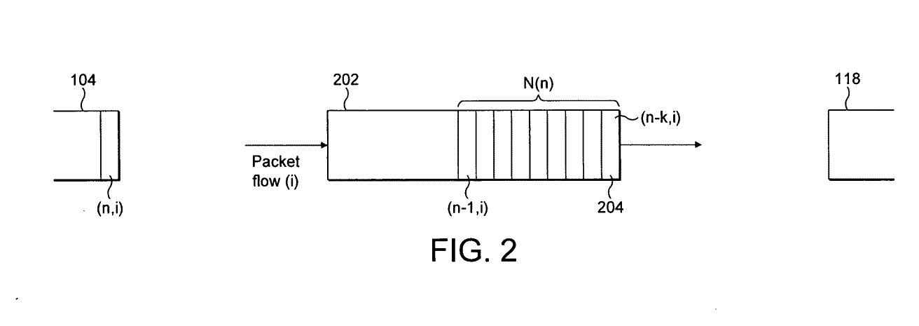

FIG. 2 is a schematic diagram illustrating a packet queue at the bottleneck buffer. The flow of data packets transmitted from the transmitter of the first user terminal 104 to the receiver of the second user terminal 118 is denoted as packet flow i. Data packets 204 from packet flow i are queued in the bottleneck buffer 202. In the packet stream, the sequence of numbers of the packets are denoted using n. FIG. 2 illustrates a packet (n,i) about to be transmitted and k preceding packets already having been transmitted, queued at the buffer 202. In this case, since the packet flow i is the only packet flow using the buffer the total queue length is equivalent to the amount of data from packet flow i queued in the buffer N(n).

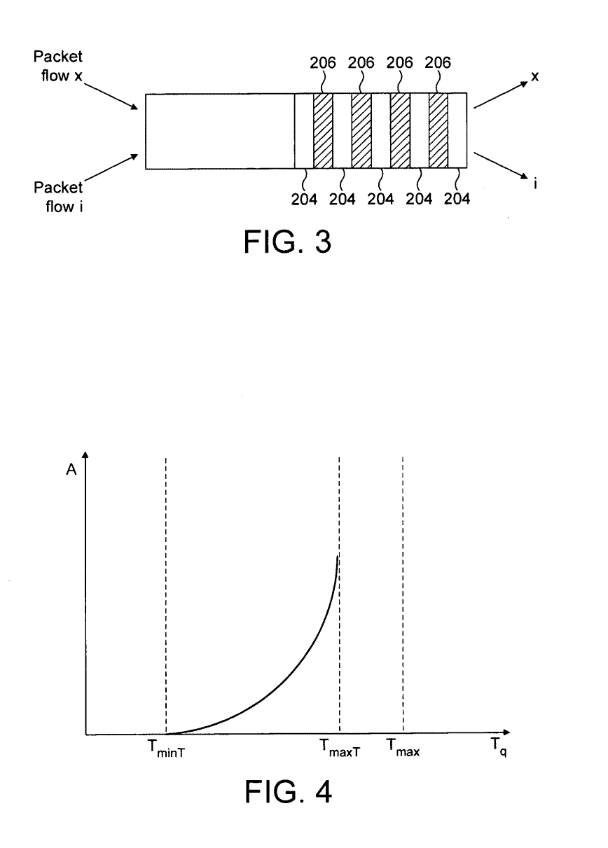

Reference is again made to FIG. 1. FIG. 1 shows a packet flow x transmitted from a third terminal 122 to a fourth terminal 124. As shown, both flows are handled by a router 120 denoted by Z. FIG. 3 shows the buffer 202 of router Z that receives packets 204 from packet flow i and packets 206 from packet flow x. Since packet flow x uses the same buffer as packet flow i, packet flow x may be referred to as ‘cross traffic’ to packet flow i. If the transmission rate of the cross traffic increases if there is available buffer capacity, such as in TCP, this will be referred to as ‘competing’ cross traffic, since the cross traffic competes for space in the buffer.

In this case the total queue length is equal to

N(n)_{flow i}+N(n)_{flow x}

As discussed previously, the inventors have identified that controlling the target amount of data queued from a packet flow N_{T} to keep the average queue length, within a predefined operating range, according to Equation 4 as performed in D+M TCP suffers from two problems. If the packet flow i shares the buffer with competing cross traffic such as TCP traffic, packet flow i may have an unnecessarily small share of the buffer. Conversely, in the event that there is no competing cross traffic, packet flow i may incur unnecessary delay at the buffer.

The inventors of the current invention have recognised the need to reduce queuing delay when there is no competing cross traffic at the bottleneck buffer, whilst enabling a fair share of buffer capacity when there is competing cross traffic.

According to an embodiment of the invention the target amount of data queued in a network buffer is forced to decrease in response to determining that packet loss and/or delay will improve in response to reducing the sending rate. In this manner the delay incurred at the buffer does not remain high when there is no competing cross traffic. If conversely it is determined that packet loss and/or delay will not improve in response to reducing the sending rate, the target amount of data queued at the buffer is not forced to decrease and may be increased. In this manner a fair share of the buffer is maintained in the presence of competing cross traffic.

According to an embodiment of the invention the target amount of data queued from a packet flow N_{T} is adapted in dependence on the determined effect of reducing the sending rate. If it is determined that packet loss and/or delay, will not improve in response to reducing the sending rate, the target amount of queued data from a flow is set to be:

N_{T}=α/ [symbol] (p_{BL})

where p_{BL} is a marking probability based on approaching an queue length limit that is dependent on the buffer capacity.

If however it is determined that packet loss and/or delay, will improve in response to reducing the sending rate, the target number of queued packets from a flow N_{T} is set to be:

N_{T}=α/ [symbol] (p_{TD})

where p_{TD} is a marking probability based on approaching a queue length that incurs a target maximum delay.

Where the normalising function is a convex function, for example:

$$Λ ( p ) = \{ \begin{matrix}\frac{2 * p}{1 - 2 * p} , if p < 0.5 ; \\ ∞ , if p \geq 0.5 ; \end{matrix} \qquad Equation ( 5 )$$

In one embodiment of the invention the normalising function [symbol] (p_{BL}) is determined from the marking probability p_{BL} that may be calculated from ECN marking implemented at an AQM enabled router. However, currently only 20% of routers enable AQM and ECN functions. The rate controller used in a preferred embodiment of the invention and described in a co-pending application uses a method that permits the target buffer set point to be determined without the need for the router to perform ECN. This is achieved by monitoring the queuing delay T_{q} to estimate the marking probability as will now be described.

The buffer 202 outputs packets at a substantially constant rate. The time spent by packet (n,i) in the buffer queue, hereinafter referred to as the queuing delay T_{q}(n), is dependent on the number of packets queued at the buffer. The number of packets N(n) from flow i queued at the buffer may be estimated as:

N(n)=R(n)*T_{q}(n) Equation (6)

For routers operating AQM, the marking probability p_{BL} is a function of the buffer limit Qmax and the average queue length avgQ:

p_{BL}=f(avgQ,Qmax)

There are a number of known ways to derive a value for p_{BL}. For example, one method used at routers employing RED (Random Early Detection). To ensure that the risk of the buffer filling up is detected early, routers employing RED calculate the marking probability compared to two thresholds, a minimum target queue length (min_{T}) and a maximum target queue length (max_{T}). The maximum threshold queue length maxₜₕ is chosen to be less than the maximum buffer length, and the minimum threshold queue length min_{T} is chosen to be less than the maximum threshold queue length max_{T}. When the average queue size avgQ is greater than a maximum threshold, all packets are marked. When the average queue size avgQ is less than the minimum threshold no packets are marked. When the average queue size falls between the minimum and maximum threshold the probability is calculated according to:

p_{BL}=maxₚ(agvQ−min_{T})/(max_{T}−min_{T})

where maxₚ is the marking probability set for when the average queue length is equal to the maximum target queue length.

As the number of packets in the buffer increase, the delay incurred by queuing at the buffer will also increase. As such, the inventors have found that the same function f used to calculate a value for p_{BL} from the queue length may instead be used to estimate p_{BL} from the queuing delay T_{q}:

p_{BL}=f(T_{avgq},Tₘₐₓ)

Where in one embodiment of the invention the marking probability is defined as:

p_{BL}=maxₚ(T_{avgq}−T_{minT})/(T_{maxT}−T_{minT}) Equation (7)

Where T_{avgq} is the average observed queuing delay, Tₘₐₓ is the maximum observed queuing delay, T_{minT} is a minimum target value for the queuing delay, T_{maxT} is a maximum target value for the queuing delay and in a preferred embodiment of the invention maxₚ is 0.5. In the same manner as RED uses two thresholds to ensure early detection of the buffer approaching capacity, T_{maxT} is set to be less than Tₘₐₓ and T_{minT} is set to be less than T_{maxT}.

The maximum delay observed queuing delay Tₘₐₓ may be found by recursively averaging T_{q}(n) observations, weighting large values of Tq(n) higher than small values according to:

Tₘₐₓ(n+1)=w_{T}Tₘₐₓ(n)+(1−w_{T})T_{q}(n)

if T_{q}(n)≧Tₘₐₓ(n), w_{T}=0.99
else w_{T}=0.9;
where w_{T} is a weighting factor.

Similarly the average queuing delay T_{avgq} may be estimated using the weighted average

T_{avgq}(n+1)=w_{T}T_{avgq}(n)+(1−w_{T})T_{q}(n)

where w_{T}=0.99

Therefore, from equations 5 and 7 the normalizing function [symbol] (p_{BL}) may be written as:

[symbol]

(p)= [symbol] (T_{q},T_{maxT}T_{minT})

As shown in FIG. 4 [symbol] (p) is a convex function. If T_{q}=Tₘᵢₙ; [symbol] (.)=0; however if T_{q}=T_{maxT}, [symbol] (.)=∞.

When competing cross traffic is detected, the target buffer set point may then be determined according to

N_{T}=α/ [symbol] (T_{q},T_{maxT},T_{minT})

According to an embodiment of the invention, when no competing cross traffic is detected, the maximum target delay T_{maxT} and optionally the target minimum delay T_{minT} may be set to T_{maxT}′ and T_{minT}′ respectively, to achieve reduced transmission delay and/or packet loss. T_{maxT}′ may be chosen to be a predetermined value or a proportion of T_{maxT}. Similarly T_{minT}′ may be chosen to be a predetermined value or a proportion of T_{minT}. As such, when no competing cross traffic is detected, the marking probability p_{TD} for approaching a queue length that incurs a target maximum delay T_{maxT}′ is given by:

p_{TD}=maxₚ(T_{avgq}−T_{minT}′)/(T_{maxT}′−T_{minT}′)

Therefore the target amount of data queued in the buffer from a flow may then be determined according to:

N_{T}=α/ [symbol] (T_{maxT}′,T_{maxT}′)

The rate at which data packets are transmitted to achieve a target amount of queued data N_{T} of packets from flow i in the buffer is given according to Equation 3 above.

For real time communication the rate of data will fluctuate according to the amount of data required to be transferred at a given point in time. Therefore in a preferred embodiment of the invention the rate is controlled according to:

R(n+1)=BWE(n)+K(N_{T}−N(n)) Equation (8)

Where N(n) is the total number of packets of flow i queued in the buffer and BWE(n) is an estimate of the bandwidth of the data connection between the first user terminal and the second user terminal. In an alternative embodiment of the invention the rate may be controlled according to equation 3.

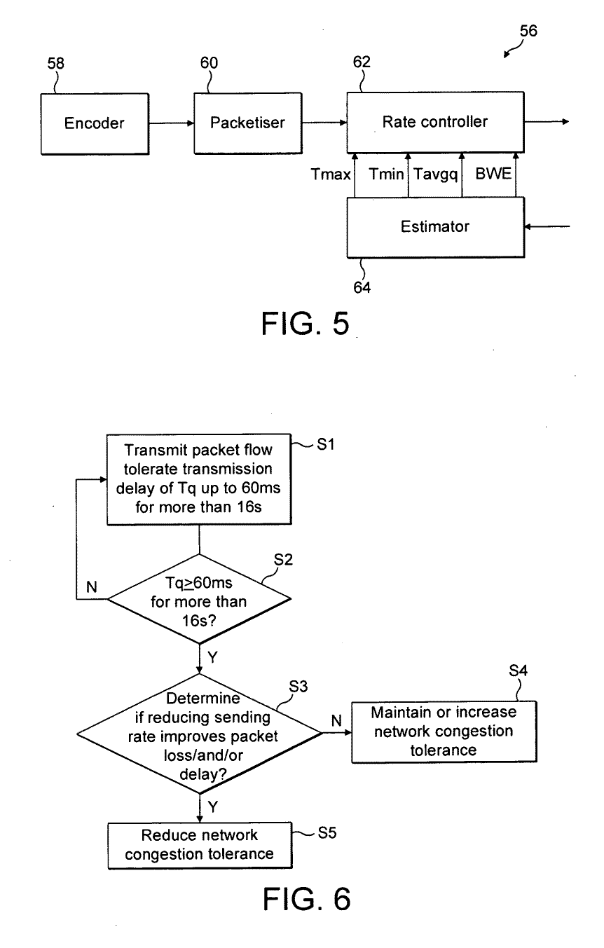

In order to describe a technique for controlling the transmission rate of data packets from the first user terminal 104 to the second user terminal 118, reference will now be made to FIG. 5. FIG. 5 illustrates a schematic block diagram of functional blocks at the transmitter 56 of user terminal 104.

An encoder 58 receives a sampled data stream input from a data input device such as a webcam or microphone (not shown) and encodes the data into an encoded bit stream for transmission the second user terminal 118.

The encoded data stream output from the encoder 58 is input into a packetiser 60. The packetiser 60 places the encoded data stream into data packets. The data packets are then input into the rate controller 62. The rate controller is arranged to control the rate that the packets are transmitted to the network. It will be appreciated that the rate controller could adjust the rate at which data is transmitted by alternatively or additionally adjusting the bit rate used to encode the data in the encoder 58, or using other methods known in the art.

An estimator block 64 receives information indicating the one way queuing delay T_{q} of packet n from the receiver of the user terminal 118. The estimator block uses T_{q} to estimate the maximum queuing delay Tₘₐₓ, the average queuing delay T_{avgq} and the minimum queuing delay Tₘᵢₙ.

In order to determine T_{q}, each packet sent from the first user terminal 104 to the second user terminal 118 is time-stamped on transmission, such as to provide in the packet an indication of the time (Tx) at which the packet was transmitted from the first terminal 104. The time (Tr) of receipt of the packet at the second terminal 118 is determined at the receiver of the second terminal 118. However, the indication provided in the packet is dependent on the value of a first clock at the first terminal 104, whereas the recorded time of receipt is dependent on the value of a second clock at the second terminal 118. Due to clock skew (or “clock offset”), the frequency of the two clocks can differ such that they are not synchronized, so the second terminal 118 does not have an accurate indication of the time at which the packet was sent from the first terminal according to the second clock. This clock offset can be estimated and eliminated over time. A suitable known method for doing this is set out in US2008/0232521, the content of which in relation to this operation is incorporated herein by reference. The method set out in US2008/0232521 also filters out (from the result of the sum: Tr−Tx) a propagation delay that the packet experiences by travelling the physical distance between the two terminals 100, 200 at a certain speed (the speed of light, when propagation over fibre optics is employed).

Thus, using the indication of (Tx) and the recorded time (Tr) of receipt and the method set out in US2008/0232521, both the clock mismatch and the propagation delay can be estimated and filtered out over time to obtain an estimate of the queuing delay “T_{q}(n)”. In alternative embodiments, other methods may be used to obtain an estimate of “T_{q}(n)”.

In preferred embodiments, the one-way queuing delay is estimated for every packet received at the second terminal 118, i.e. “n”, “n+1”, “n+2”, etc. In alternative embodiments, this delay may be estimated only for every 2^{nd} or 3^{rd} packet received at the second terminal 118. So, the estimation may be carried out every X received packet(s), where X is an integer. In alternative embodiments, the estimation may be carried out once per Y seconds, for example where Y=1.

The estimator block 64 is also arranged to estimate the bandwidth BWE of the data connection from the first user terminal 104 to the second user terminal 118.

In a preferred embodiment of the invention the estimator block 64 is arranged to use the observations of Tq received from the second terminal 118 to determine an estimate of the available bandwidth, according to:

Tq(n)=N(n)/BW(n) Equation (9)

and

N(n)=max(N(n−1,i)−(Tx(n)−Tx(n−1))*BWE(n),0)+S(n) Equation (10)

Where BW(n) is the available channel bandwidth, S(n) is the packet size of packet n, and N(n) is the amount of packet flow data in the buffer queue. The estimator block 64 may then use equations 9 and 10 to estimate the bandwidth and N(n). In one implementation for the estimator 64 the equations are used as the basis for a Kalman filter, and solve them as an extended, unscented or particle Kalman filter, yielding a bandwidth estimate BWE(n).

In alternative embodiments of the present invention the available bandwidth of the channel BW may be determined according to other bandwidth estimation techniques known in the art methods known in the art. The number of packets queued in the buffer N(n) may then be determined according to equation 10, or by N(n)=R(n)*T_{q}(n)

The estimator block 64 provides T_{q}, Tₘₐₓ, T_{avgq}, BWE and N(n) to the rate controller 62. The rate controller is then arranged to control the rate according to Equation 8.

R(n+1)=BWE(n)+K(N_{T}−N(n))

According to an exemplary embodiment of the invention, the rate controller 62 is arranged to determine the rate at which packets are transmitted to the second terminal by setting the target maximum queuing delay and the target minimum queuing delay according to the method illustrated in FIG. 6.

FIG. 6 shows a flow chart showing method steps according to one embodiment of the invention.

In step S1 the rate controller transmits packets at a rate that is controlled to tolerate a threshold queuing delay T_{q}. In an exemplary embodiment of the invention the threshold packet delay T_{q} is set to be 60 ms which persists for the duration of 16 seconds.

In step S2, it is determined if the threshold queuing delay has been exceeded. If the queuing delay T_{q} exceeds 60 ms for more than 16 seconds the method continues to step S3, otherwise the method returns to step S1.

In step S3 it is determined if the queuing delay may be reduced beyond a threshold amount. In this example the rate controller 62 lowers the rate of packet transmission to attempt to achieve a maximum queuing delay of 40 ms for 16 seconds. If the observed queuing delay is not reduced to below 60 ms a flag is F_tcp is set to 1 in the rate controller to indicate the presence of TCP cross traffic and the method continues to S4, otherwise the flag is set to 0 in the rate controller and the method continues to step S5.

In step S4, if the flag F_tcp is set to 1, the rate controller is arranged to set the target maximum queuing delay to be T_{maxT}, where T_{maxT} is a proportion of the maximum observed queuing delay Tₘₐₓ. Tₘᵢₙ may be set to be a smaller proportion of Tₘₐₓ. For example:

### if F_tcp=1

set

### T_{maxT}=0.75*Tₘₐₓ

and

### T_{minT}=0.5*Tₘₐₓ

If however in step S3 it is determined that the queuing delay is reduced in response to lowering the rate of packet transmission such that the flag F_tcp is set to 0, in step S5 the rate controller is arranged to set the target maximum queuing delay to be T_{maxT′}, where T_{maxT′} is a low value, such as a predetermined value or a smaller proportion of Tₘₐₓ than T_{maxT}. T_{minT′} is set to be less than T_{maxT} For example:

### if F_tcp=0

set

### T_{maxT′}=0.04 s

and

### T_{minT′}=0.006 s

This results in reduced queuing delay and packet loss, thus improving the perceived quality of the received data stream output to User B 114 of the second terminal 118. The method then returns to step S1

As illustrated by the graph shown in FIG. 4, and in step S4 of FIG. 6, in a preferred embodiment of the invention the target maximum queuing delay T_{maxT} is set to be less than the maximum queuing delay Tₘₐₓ. This allows persistently high queuing delay to be avoided in the event that it is incorrectly determined in step S3 that reducing the sending rate will not improve packet loss and/or delay.

While this invention has been particularly shown and described with reference to preferred embodiments, it will be understood to those skilled in the art that various changes in form and detail may be made without departing from the scope of the invention as defined by the claims.

For example, in an alternative embodiment of the invention the effect of reducing the transmission rate may be determined by detecting the presence of cross traffic by probing the data connection using a method known as packet pair probing. According to this method data packets are sent at different transmission intervals to determine if packets sent back to back experience less delay than delay caused by cross traffic experienced by packets sent at predetermined intervals.

In a further alternative embodiment of the invention the average queuing delay T_{avgq}, the maximum queuing delay Tₘₐₓ and the minimum queuing delay T_{q} may be determined by analysing a number of observations of queuing delay T_{q}. For example the maximum queuing delay and average queuing delay could be determined from 100 observations of the queuing delay T_{q}. As such T_{q}, Tₘₐₓ and Tₘᵢₙ could be updated for every 100 observation of T_{q}.

Whilst the in the exemplary method described above the target amount of queued data N_{T} is determined at the transmitter of the first terminal 104, in alternative embodiments of the invention any of T_{avgq}, Tₘₐₓ, Tₘᵢₙ, T_{maxT}, T_{minT}, T_{maxT′}, T_{minT′}, N_{T} and R(n) may be determined instead at the receiver of the second terminal 118 and provided to the transmitter.

Whilst embodiments of the invention have been described as controlling the rate to maintain an adaptive target amount of data in the queue that is dependent on the marking probability, to enable the buffer to be shared, it should be appreciated that in another embodiment of the invention the rate may be controlled to maintain a first target queue length if an indication of cross traffic is detected and a second target queue length if no indication of cross traffic is detected.

In preferred embodiments, the processes discussed above are implemented by software stored on a general purpose memory such as flash memory or hard drive and executed on a general purpose processor, the software preferably but not necessarily being integrated as part of a communications client. However, alternatively the processes could be implemented as separate application(s), or in firmware, or even in dedicated hardware.

Any or all of the steps of the method discussed above may be encoded on a computer-readable medium, such as memory, to provide a computer program product that is arranged so as, when executed on a processor, to implement the method.

What is claimed is:

1. A method of controlling transmission of data transmitted in packets from a transmitter to a receiver via a channel, the method comprising:
transmitting packets from the transmitter to the receiver; and
determining if the transmission delay and/or loss of subsequent packets transmitted to the receiver may be reduced beyond a threshold amount;
controlling the transmission rate to be dependent on a first target delay if it is determined that the transmission delay and/or loss of subsequent packets transmitted to the receiver may not be reduced beyond a threshold amount; and
controlling the transmission rate to be dependent on a second target delay if it is determined that the transmission delay and/or loss of subsequent packets transmitted to the receiver may be reduced beyond a threshold amount, wherein the second target delay is lower relative to the first target delay.

2. A method as claimed in claim 1 wherein the step of determining if the transmission delay and/or loss of subsequent packets transmitted to the receiver may be reduced beyond a threshold amount comprises determining an indication of cross traffic on the channel.

3. A method as claimed in claim 2 wherein the cross traffic is competing cross traffic.

4. A method as claimed in claim 2 wherein packet pair probing is used to determine an indication of cross traffic.

5. A method as claimed in claim 1 wherein the step of determining if the transmission delay and/or loss of subsequent packets transmitted to the receiver may be reduced beyond a threshold amount comprises the steps of:
monitoring transmission delay of a first set of packets and a second set of packets wherein the second set of packets is transmitted subsequent to the first set of packets;
reducing the rate of data transmitted in the second set of packets relative to the first; and
determining if the transmission delay and/or loss of at least one of said second set of packets is less than the first.

6. A method as claimed in claim 5 wherein the step of reducing the rate of data transmitted in the second set of packets comprises; controlling the second set of packets to be transmitted in dependence on a lower target delay than the first set of packets.

7. A method as claimed in claim 6, wherein the step of monitoring the transmission delay comprises:
determining a transmission time for each packet, based on a transmission clock;
determining a reception time of each packet, based on a reception clock;
estimating a clock error between the transmission clock and the reception clock, and filtering the clock error.

8. A method as claimed in claim 1 wherein the step of controlling the transmission rate to be dependent on the first target delay comprises controlling the transmission rate to maintain a first target amount of data queued in a buffer in the network, wherein the target amount of data queued in the buffer is proportional to the capacity of the buffer in the network.

9. A method as claimed in claim 8 wherein the rate is controlled in dependence on the estimated bandwidth of the channel and the difference between the target amount of data in the network buffer and the actual amount of data in the network buffer.

10. A method as claimed in claim 8 wherein the step of controlling the transmission rate to be dependent on the second target delay comprises maintaining a second target amount of data queued in the buffer the network, wherein the second target amount of data queued in the buffer less than the first target amount of data queued in the buffer.

11. A method as claimed in claim 8 wherein the target amount of data queued in the buffer relates to the total amount of data queued in the buffer, or to the data provided in said packets transmitted from the transmitter to the receiver.

12. A method as claimed in claim 8 wherein the step of controlling the transmission rate to maintain the first target amount of data queued in the buffer comprises:
determining a marking probability of a packet;
determining the first target amount of data queued in the buffer from the marking probability; and
controlling the transmission time of the packet in order to adapt the amount of data queued in a buffer to be equivalent to the first target amount of data.

13. A method as claimed in claim 12 wherein the marking probability is determined from an explicit congestion notification implemented at the router.

14. A method as claimed in claim 12 wherein the step determining the marking probability comprises:
observing the transmission delay of a plurality of packets transmitted to the buffer; and
estimating the marking probability of a packet based on an observed average delay and an observed maximum delay at the time that the packet is sent.

15. A method as claimed in claim 1 wherein the transmission delay is a queuing delay.

16. A method as claimed in claim 1 wherein the step of determining if the transmission delay and/or loss of subsequent packets transmitted to the receiver may be reduced beyond a threshold amount comprises determining if the transmission delay and or loss may be reduced by more than the threshold amount.

17. A method as claimed in claim 16, wherein the threshold amount is the threshold amount is a predetermined amount equal to or more than zero.

18. A method as claimed in claim 1 wherein the step of determining if transmission delay and/or loss of subsequent packets transmitted to the receiver may be reduced beyond a threshold amount comprises determining if the transmission delay and or loss may be reduced below a threshold amount.

19. A method as claimed in claim 18 wherein the threshold amount is a proportion of the maximum queuing delay.

20. A method of controlling transmission of data from a transmitter to a receiver via a channel, the method comprising:
transmitting data from the transmitter to the receiver; and
determining if the transmission delay and/or loss of subsequent packets transmitted to the receiver may be reduced beyond a threshold amount;
controlling the transmission rate to maintain a first target amount of data transmitted from the transmitter to the receiver queued in the channel if it is determined that the transmission delay and/or loss of subsequent packets transmitted to the receiver may be not be reduced beyond the threshold amount; and
controlling the transmission rate to maintain a second target amount of data transmitted from the transmitter to the receiver queued in the channel if it is determined that the transmission delay and/or loss of subsequent data transmitted to the receiver may be reduced beyond the threshold amount, wherein the second target amount of data is lower relative to the first target amount of data.

21. A transmitter for transmitting data provided in packets to a receiver via a channel, the transmitter comprising:
a determiner configured to determine if the transmission delay and/or loss of subsequent packets transmitted to the receiver may be reduced beyond a threshold amount; and
a controller configured to control the transmission rate to be dependent on a first target delay if it is determined that the transmission delay and/or loss of subsequent packets transmitted to the receiver may not be reduced beyond a threshold amount; and configured to control the transmission rate to be dependent on a second target delay if it is determined that the transmission delay and/or packet loss may be reduced beyond a threshold amount, wherein the second delay tolerance is lower relative to the first delay tolerance.

22. A receiver arranged to receive data provided in packets transmitted from a transmitter via a channel, the receiver comprising:
a determiner configured to determine if the transmission delay and/or loss of subsequent packets transmitted to the receiver may be reduced beyond a threshold amount; and
a controller configured to control the transmission rate to be dependent on a first target delay if it is determined that the transmission delay and/or loss of subsequent packets transmitted to the receiver may not be reduced beyond a threshold amount; and configured to control the transmission rate to be dependent on a second target delay if it is determined that the transmission delay and/or loss of subsequent packets transmitted to the receiver may be reduced beyond a threshold amount, wherein the second delay tolerance is lower relative to the first delay tolerance.

23. A receiver as claimed in claim 22 wherein the controller comprises:
a monitor configured to monitor the transmission delay of packets received from the transmitter; and
a provider configured to provide at least one of the transmission delay, a bandwidth estimation or a requested transmission rate to the transmitter in order to control the transmission rate.

24. A computer program product comprising code arranged so as when executed on a processor to perform the steps of claim 1.

25. A computer program product comprising code arranged so as when executed on a processor to perform the steps of claim 20.
